(19) United States
(12) Patent Application Publication
(10) Pub. No.: US 2008/0108328 A1
(43) Pub. Date: May 8, 2008

(54) System and Method for Enhanced Public Address System

(75) Inventor: Robert C. Lovell, Leesburg, VA (US)

Correspondence Address: EDELL, SHAPIRO & FINNAN, LLC, 1901 RESEARCH BOULEVARD, SUITE 400, ROCKVILLE, MD, 20850, US

(73) Assignee: SYBASE 365, INC., Chantilly, VA (US)

(21) Appl. No.: 11/936,862

(22) Filed: Nov. 8, 2007

Related U.S. Application Data
(60) Provisional application No. 60/857,500, filed on Nov. 8, 2006.

(51) Int. Cl. H04L 12/58; H04Q 7/20

(52) U.S. Cl. 455/412.1; 455/422.1; 455/456.1; 455/466

(57) ABSTRACT

A service that leverages established wireless messaging paradigms such as, possibly inter alia, Short Message Service, Multimedia Message Service, Wireless Application Protocol, and IP Multimedia Subsystem to yield an infrastructure that enhances aspects of a conventional Public Address System (as found at, for example, an airport, a train station, a conference or convention center, a sporting event, a concert, etc.) and allows a Mobile Subscriber to seamlessly employ their Wireless Device to interact with same. The service may optionally leverage the capabilities of a centrally-located Messaging Inter-Carrier Vendor.

This application claims the benefit of U.S. Provisional Patent Application No. 60/857,500, filed on Nov. 8, 2006, which is herein incorporated by reference in its entirety.

### BACKGROUND

1. Field of the Invention

The present invention relates generally to telecommunications services. More particularly, the present invention relates to capabilities that enhance substantially the value and usefulness of various wireless messaging paradigms including, inter alia, Short Message Service (SMS), Multimedia Message Service (MMS), Wireless Application Protocol (WAP), Internet Protocol (IP) Multimedia Subsystem (IMS), etc.

2. Background of the Invention

As the ‘wireless revolution’ continues to march forward the importance to a Mobile Subscriber (MS)—for example a user of a Wireless Device (WD) such as a mobile telephone, BlackBerry, etc. that is serviced by a Wireless Carrier (WC)—of their WD grows substantially. One consequence of such a growing importance is the resulting ubiquitous nature of WDs—i.e., MSs carry them at almost all times.

On many occasions a MS may find themselves at a venue—e.g., an airport, a train station, a bus station, a conference or convention center, a sporting event, a concert, etc.—that is loud, noisy, etc. making it difficult for the MS to hear, and understand, the venue's Public Address System (PAS).

The difficulty (i.e., of a MS hearing, and understanding, a venue's PAS) may be exacerbated if the MS is elderly, suffers from some type of hearing deficit, etc.

The present invention extends key elements of wireless messaging technology to address the difficulty (i.e., of a MS hearing, and understanding, a venue's PAS) through an enhanced or augmented PAS system, and other similarly-situated entities, and addresses various of the (not insubstantial) challenges that are associated with same.

### SUMMARY OF THE INVENTION

Embodiments of the present invention provide a service that leverages established wireless messaging paradigms such as, possibly inter alia, SMS and MMS to yield an infrastructure that, in one embodiment, provides a method of delivering public address system announcements that includes receiving notification of a location of a wireless device, sending an inquiry message to a public address system (PAS) serving the location of the wireless device regarding whether the PAS is configured to relay PAS announcements, receiving a response message from the PAS indicating its ability to relay PAS announcements, sending an update message to the wireless device indicating that the PAS is configured to relay PAS announcements to the wireless device; and receiving content of a PAS announcement from the PAS, and forwarding the content to the wireless device.

In a preferred embodiment, the wireless device may be a mobile telephone, and content may be forwarded or sent via the short message service (SMS) or the multimedia message service (MMS). This may be facilitated if, for example, the content is received as a textual equivalent of the PAS announcement. Alternatively, or in addition, the content may be received as an audio file of the PAS announcement.

In another embodiment, a method of delivering live public address system (PAS) announcements includes receiving a notification of a location of a wireless device, requesting, from an entity that operates a public address system (PAS) serving the location of the wireless device, that the entity electronically relay live PAS announcements, receiving content of a live PAS announcement relayed from the PAS, and forwarding the content to the wireless device.

In yet another embodiment, a method of distributing live public address system announcements includes receiving, at an entity that operates a public address system (PAS), an inquiry message from an entity serving a population of mobile telephones regarding whether the PAS is configured to relay content of live PAS announcements, sending a response message responsive to the inquiry message indicating that the PAS is configured to relay the content of live PAS announcements, and sending content of a given live PAS announcement from the PAS to the entity serving the population of mobile telephones.

These and other features of the embodiments of the present invention, along with their attendant advantages, will be more fully appreciated upon a reading of the following detailed description in conjunction with the associated drawings.

### BRIEF DESCRIPTION OF THE DRAWINGS

FIG. 1 is a diagrammatic presentation of an exemplary Messaging Inter-Carrier Vendor (MICV).

FIG. 2 illustrates one particular arrangement that is possible through aspects of the present invention.

FIG. 3 illustrates various of the exchanges or interactions that are supported by aspects of the present invention.

FIG. 4 illustrates further of the exchanges or interactions that are supported by aspects of the present invention.

FIG. 5 is a diagrammatic presentation of aspects of an exemplary Service Provider (SP) Application Server (AS).

It should be understood that these figures depict embodiments of the invention. Variations of these embodiments will be apparent to persons skilled in the relevant art(s) based on the teachings contained herein.

### DETAILED DESCRIPTION

The present invention may leverage the capabilities of a centrally-located, full-featured MICV facility. Reference is made to U.S. Pat. No. 7,154,901 entitled “INTERMEDIARY NETWORK SYSTEM AND METHOD FOR FACILITATING MESSAGE EXCHANGE BETWEEN WIRELESS NETWORKS,” and its associated continuations, for a description of a MICV, a summary of various of the services/functions/etc. that are performed by a MICV, and a discussion of the numerous advantages that arise from same. The disclosure of U.S. Pat. No. 7,154,901, along with its associated continuations, is incorporated herein by reference.

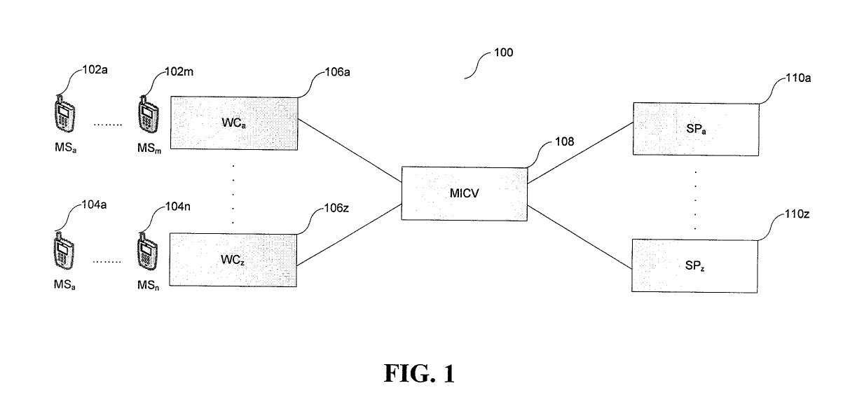

As illustrated in FIG. 1 and reference numeral 100 a MICV 108 is disposed between, possibly inter alia, multiple WCs (WCₐ 106ₐ→WC_{Z} 106_{Z}) on one side and multiple SPs (SPₐ 110ₐ→SP_{Z} 110_{Z}) on the other side and thus ‘bridges’ all of the connected entities. A MICV 108 thus, as one simple example, may offer various routing, formatting, delivery, value-add, etc. capabilities that provide, possibly inter alia:

1) A WC 106ₐ→106_{Z} (and, by extension, all of the MSs 102ₐ→102ₘ and 104ₐ→104ₙ that are serviced by the WC 106ₐ→106_{Z}) with ubiquitous access to a broad universe of SPs 110ₐ→110_{Z}, and

2) A SP 110ₐ→110_{Z} with ubiquitous access to a broad universe of WCs 106ₐ→106_{Z} (and, by extension, all of the MSs 102ₐ→102ₘ and 104ₐ→104ₙ that are serviced by the WC 106ₐ→106_{Z}).

Generally speaking a MICV may have varying degrees of visibility (e.g., access, etc.) to the (MS←→MS, MS←→SP, etc.) messaging traffic:

1) A WC may elect to route just their out-of-network messaging traffic to a MICV. Under this approach the MICV would have visibility (e.g., access, etc.) to just the portion of the WC's messaging traffic that was directed to the MICV by the WC.

2) A WC may elect to route all of their messaging traffic to a MICV. The MICV may, possibly among other things, subsequently return to the WC that portion of the messaging traffic that belongs to (i.e., that is destined for a MS of) the WC. Under this approach the MICV would have visibility (e.g., access, etc.) to all of the WC's messaging traffic.

While the discussion below will include a MICV it will be readily apparent to one of ordinary skill in the relevant art that other arrangements are equally applicable and indeed are fully within the scope of the present invention.

In the discussion below the present invention is described and illustrated as being offered by a SP. A SP may, for example, be realized as a third-party service bureau, an element of a WC or a landline carrier, an element of a MICV, multiple third-party entities working together, etc.

To better understand the particulars of the present invention consider for a moment a simple hypothetical example—SP SPₓ offers a service that has been enhanced or augmented as provided through elements of the instant invention and Mary, a MS, uses SPₓ's service.

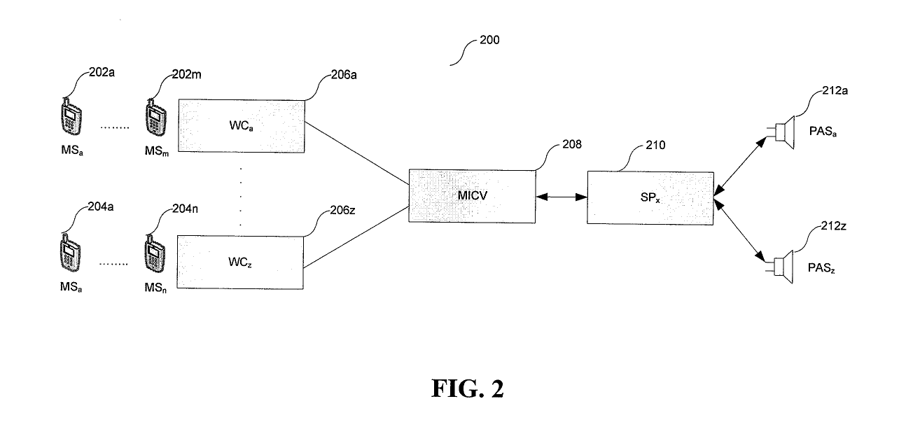

FIG. 2 and reference numeral 200 depict one possible arrangement under which our hypothetical example might operate. In brief, a number of MSs (MSₐ 202ₐ→MSₘ 202ₘ and MSₐ 204ₐ→MSₙ 204ₙ), including Mary, may interact in rich and complete ways with a range of enhanced or augmented PASs (PASₐ 212ₐ→PAS_{Z} 212_{Z}) through the services, capabilities, etc. that are offered by SPₓ 210.

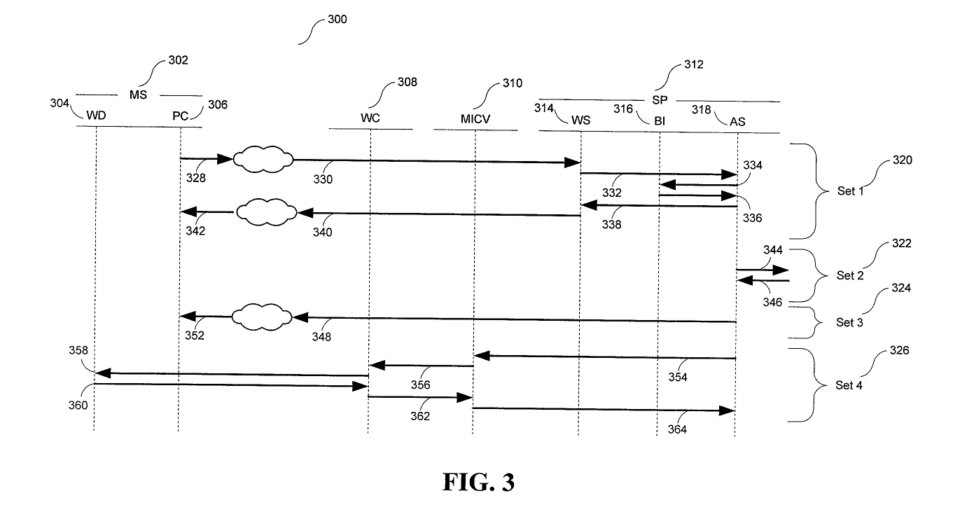

FIG. 3 and reference numeral 300 illustrate various of the exchanges or interactions that might occur under a portion of our hypothetical example. Of interest and note in the diagram are the following entities:

MS 302 WD 304. For example, Mary's WD such as a mobile telephone, BlackBerry, PalmPilot, etc.

MS 302 Personal Computer (PC) 306. For example, one of Mary's home, work, etc. PCs.

WC 308. The provider of service for Mary's WD.

MICV 310. As noted above the use of a MICV, although not required, provides significant advantages.

SP 312 Web Server (WS) 314. A publicly-available World Wide Web (WWW) site that is optionally provided by SPX.

SP 312 Billing Interface (BI) 316. A single, consolidated interface that SPₓ may use to easily reach, inter alia, one or more external entities such as a credit card or debit card clearinghouse, a carrier billing system, a service bureau that provides access to multiple carrier billing systems, etc.

SP 312 AS 318. Facilities that provide key elements of the instant invention (which will be described below).

It is important to note that in FIG. 3:

1) The MS 302 WD 304 and MS 302 PC 306 entities are illustrated as being adjacent or otherwise near each other. In actual practice the entities may, for example, be physically located anywhere.

2) The messages are shown traversing a MICV 310.

3) The SP 312 may employ a Short Code (SC) or a regular Telephone Number (TN) as its source address (and to which it would ask users of its service to direct any messages). While the abbreviated length of a SC (e.g., five digits for a SC administered by Neustar under the Common Short Code [CSC] program) incrementally enhances the experience of a MS (e.g., the MS need remember and enter only a few digits as the destination address of a message) it also, by definition, constrains the universe of available SCs thereby causing each individual SC to be a limited or scarce resource and raising a number of SC/CSC management, etc. issues. A description of a common (i.e., universal) short code environment may be found in pending U.S. patent application Ser. No. 10/742,764 entitled “UNIVERSAL SHORT CODE ADMINISTRATION FACILITY.”

4) In the discussion to follow, reference is made to messages that are sent, for example, between a MS (e.g., Mary) 302 and an SP (e.g., SPₓ) 312. As set forth below, a given “message” sent between Mary 302 and SPₓ 312 may actually comprise a series of steps in which the message is received, forwarded and routed between different entities, including a mobile phone associated with Mary 302, a WC 308, a MICV 310, and SPₓ 312. Thus, unless otherwise indicated, it will be understood that reference to a particular message, such as, for example, a reply message, generally includes that particular message as conveyed at any stage between an origination source, such as Mary's mobile phone 304, and an end receiver, such as SPₓ 312. As such, reference to a particular message generally includes a series of related communications between, for example, Mary 302 and a WC 308, the WC 308 and a MICV 310, and the MICV 310 and SPₓ 312. The series of related communications may, in general, contain substantially the same information, or information may be added or subtracted in different communications that nevertheless may be generally referred to as a same message. To aid in clarity, a particular message, whether undergoing changes or not, is referred to by different reference numbers at different stages between a source and an endpoint of the message.

In FIG. 3 the exchanges that are collected under the designation Set 1 320 represent the activities that might take place as Mary 302 completes an optional registration process with SPₓ 312. For example:

A) As depicted through 328/330 . . . Mary 302 uses one of her PCs 306 to visit SPₓ's WS 314 to, possibly among other things, complete a service registration process.

B) As depicted through 332 . . . SPₓ's WS 314 interacts with SPₓ's AS 318 to, possibly among other things, commit some or all of the information that Mary 302 provided to a data repository (e.g., a database), optionally complete a billing transaction, etc.

C) As depicted through 334/336/338 . . . As appropriate and as required a BI 316 completes a billing transaction.

D) As depicted through 340/342 . . . SPₓ's WS 314 responds appropriately (e.g., with the presentation of a confirmation message, etc.).

The specific exchanges that were described above (as residing under the designation Set 1 320) are illustrative only and it will be readily apparent to one of ordinary skill in the relevant art that numerous other exchanges are easily possible and indeed are fully within the scope of the present invention. As just one example, the registration process may be completed through any combination of one or more channels including, inter alia, the indicated WWW facility, wireless messaging (SMS, MMS, IMS, etc.), E-mail messages, Instant Messaging (IM) exchanges, conventional mail, telephone, Interactive Voice Response (IVR) facilities, etc.

During the registration process that was described above a range of information may be captured from a MS including, inter alia:

1) Identifying Information (e.g., general information about Mary). For example, possibly among other things, a unique identifier and a password, optionally a pseudonym or handle, name, address, age, etc.

2) Billing Information. Different service billing models may be offered by SPₓ including, possibly inter alia, free (e.g., possibly advertising-based), a fixed one-time charge, a recurring (hourly, daily, monthly, etc.) fixed charge, a recurring (hourly, daily, monthly, etc.) variable charge, a per-use charge, etc. Different payment mechanisms may be supported by SPX including, possibly among other things, credit or debit card information, authorization to place a charge on a MS's phone bill, etc.

The specific pieces of information that were described above are illustrative only and it will be readily apparent to one of ordinary skill in the relevant art that numerous other pieces of information are easily possible and indeed are fully within the scope of the present invention.

As noted above the information that Mary provided during the registration process may be preserved in a data repository (e.g., a database) and may optionally be organized as a MS Profile.

The content of Mary's profile may optionally be augmented by SPₓ. For example, one or more internal or external sources of consumer, demographic, psychographic, etc. information may be leveraged to selectively enhance or augment elements of Mary's profile.

As noted above, a SP's BI may optionally complete a billing transaction. The billing transaction may take any number of forms and may involve different external entities (e.g., a WC's billing system, a carrier billing system service bureau, a credit or debit card clearinghouse, etc.). The billing transaction may include, inter alia:

1) The appearance of a line item charge on the bill or statement that a MS receives from her WC. Exemplary mechanics and logistics associated with this approach are described in pending U.S. patent application Ser. No. 10/837,695 entitled “SYSTEM AND METHOD FOR BILLING AUGMENTATION.” Other ways of completing or performing line item billing are easily implemented by those skilled in the art.

2) The charging of a credit card or the debiting of a debit card.

In FIG. 3 the exchanges that are collected under the designation Set 2 322 (i.e., 344 and 346) represent the activities that might take place as SPX registers, coordinates, etc. with outside or external entities (including, inter alia, various PASs) to, possibly among other things, secure access, arrange to receive updates, etc.

The specific exchanges that were described above (as residing under the designation Set 2 322) are illustrative only and it will be readily apparent to one of ordinary skill in the relevant art that numerous other exchanges (including, inter alia, updates to various of the information in a MS Profile in a SP's repository, etc.) are easily possible and indeed are fully within the scope of the present invention.

In FIG. 3 the exchanges that are collected under the designation Set 3 324 represent the activities that might take place as SPX 312 dispatches to Mary 302 one or more confirmation E-mail messages (348 and 352).

The specific exchanges that were described above (as residing under the designation Set 3 324) are illustrative only and it will be readily apparent to one of ordinary skill in the relevant art that numerous other exchanges (including, inter alia, other types or forms of confirmation messages) are easily possible and indeed are fully within the scope of the present invention.

In FIG. 3 the exchanges that are collected under the designation Set 4 326 represent the activities that might take place as SPₓ's AS 318 dispatches one or more confirmation SMS, MMS, IMS, etc. messages (354/356/358) to Mary's WD 304 and Mary 302 replies or responds to the message(s) (360/362/364)). In the instant example the messages are shown traversing a MICV 310. The SP 312 may employ a or a regular TN as its source address (and to which it would ask users of its service to direct any reply messages).

The specific exchanges that were described above (as residing under the designation Set 4 326) are illustrative only and it will be readily apparent to one of ordinary skill in the relevant art that numerous other exchanges are easily possible and indeed are fully within the scope of the present invention.

The Set 1 320, Set 2 322, Set 3 324, and Set 4 326 exchanges that were described above are illustrative only and it will be readily apparent to one of ordinary skill in the relevant art that numerous other exchanges are easily possible and indeed are fully within the scope of the present invention.

The information that was described above may, after it is collected or gathered, be subsequently managed (e.g., existing information may be edited or removed, new information may be added, etc.) through any combination of one or more channels including, inter alia, a SP's WWW facility, wireless messaging (SMS, MMS, IMS, etc.), E-mail messages, IM exchanges, conventional mail, telephone, IVR facilities, etc.

To continue with our hypothetical example . . . After completing the optional registration process Mary may, during the course of her normal daily activities, physically enter an venue whose PAS has been enhanced or augmented through aspects of the instant invention.

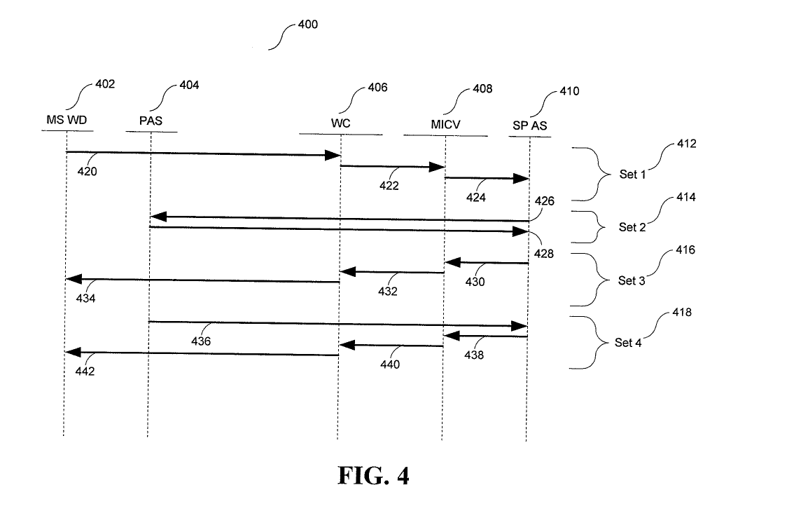

FIG. 4 and reference numeral 400 illustrate various of the exchanges or interactions that might occur under this portion of our hypothetical example. Of interest and note in the diagram are the following entities:

MS WD 402. For example, Mary's WD such as a mobile telephone, BlackBerry, PalmPilot, etc.

PAS 404. The venue's PAS (that has been enhanced or augmented through aspects of the instant invention).

WC 406. The provider of service for Mary's WD.

MICV 408. As noted previously the use of a MICV, although not required, provides significant advantages.

SP AS 410. SPₓ's AS that provide key elements of the instant invention (which will be described below).

It is important to note that in FIG. 4:

1) The messages are shown traversing a MICV 408.

2) SPₓ 410 may employ a SC or a regular TN as its source address (and to which it would ask users of its service to direct any messages).

In the discussion to follow, reference is made to messages that are sent, for example, between a MS (e.g., Mary) 402 and an SP (e.g., SPₓ) 410. As set forth below, a given “message” sent between Mary 402 and SPX 410 may actually comprise a series of steps in which the message is received, forwarded and routed between different entities, including a mobile phone associated with Mary 402, a WC 406, a MICV 408, and SPₓ 410. Thus, unless otherwise indicated, it will be understood that reference to a particular message, such as, for example, a notification message, generally includes that particular message as conveyed at any stage between an origination source, such as Mary's mobile phone 402, and an end receiver, such as SPX 410. As such, reference to a particular message generally includes a series of related communications between, for example, Mary 402 and a WC 406, the WC 406 and a MICV 408, and the MICV 408 and SPX 410. The series of related communications may, in general, contain substantially the same information, or information may be added or subtracted in different communications that nevertheless may be generally referred to as a same message. To aid in clarity, a particular message, whether undergoing changes or not, is referred to by different reference numbers at different stages between a source and an endpoint of the message.

In FIG. 4 the exchanges that are collected under the designation Set 1 412 represent the activities that might take place as Mary physically enters a venue whose PAS has been augmented or enhanced through aspects of the instant invention. For example:

A) As depicted through 420/422/424 . . . Either explicitly (e.g., through the dispatch of, possibly inter alia, a notification SMS/MMS/IMS/etc. message that is addressed to a SC, TN, etc.) or automatically (e.g., through, possibly inter alia, Location-Based Services (LBS) or Global Positioning System (GPS), BlueTooth, WiFi, etc.) SPₓ's AS 410 is notified of the discovery, recognition, etc. of Mary's WD 402 within the venue.

The specific exchanges that were described above (as residing under the designation Set 1 412) are illustrative only and it will be readily apparent to one of ordinary skill in the relevant art that numerous other exchanges (including, inter alia, other types or forms of notification messages) are easily possible and indeed are fully within the scope of the present invention.

In FIG. 4 the exchanges that are collected under the designation Set 2 414 represent the activities that might take place as SPₓ's AS 410 interacts with the PAS 404. For example:

A) As depicted through 426 . . . SPₓ's AS 410 may dispatch one or more inquiry, status, registration, request, etc. message(s) to PAS 404.

B) As depicted through 428 . . . PAS 404 may dispatch one or more response, reply, etc. messages to SPₓ's AS 410.

The specific exchanges that were described above (as residing under the designation Set 2 414) are illustrative only and it will be readily apparent to one of ordinary skill in the relevant art that numerous other exchanges (including, inter alia, other types or forms of inquiry/status/registration/request/etc. and response/reply/etc. messages) are easily possible and indeed are fully within the scope of the present invention.

In FIG. 4 the exchanges that are collected under the designation Set 3 416 represent the activities (430/432/434) that might take place as SPₓ's AS 410 dispatches one or more update (e.g., SMS, MMS, IMS, etc.) messages to Mary's WD 402. For example, an update message might alert Mary to, possibly inter alia, the fact that Mary's physical presence in the venue has been recognized and that the venue's PAS is in fact enhanced/augmented/configured to relay PAS announcements to a wireless devices.

The specific exchanges that were described above (as residing under the designation Set 3 416) are illustrative only and it will be readily apparent to one of ordinary skill in the relevant art that numerous other exchanges (including, inter alia, other types or forms of update messages) are easily possible and indeed are fully within the scope of the present invention.

In FIG. 4 the exchanges that are collected under the designation Set 4 418 represent the activities that might take place as SPₓ's AS 410 receives a public announcement message 436 from the PAS 404 and passes the announcement along 438/440/442 (as, possibly inter alia, one or more SMS/MMS/IMS/etc. announcement messages) to Mary's WD 402. For example:

A) As depicted through 436 . . . When a public announcement (e.g., a live announcement) is issued through the venue's PAS 404 the PAS 404 may dispatch the content of that announcement to SPₓ's AS 410.

B) As depicted through 438/440/442 . . . After receiving the content of a public announcement from the PAS 404 SPₓ's AS 410 may, possibly among other things, perform a number of processing activities and then generate and dispatch one or more (SMS/MMS/IMS/etc.) announcement messages to Mary's WD 402.

The specific exchanges that were described above (as residing under the designation Set 4 418) are illustrative only and it will be readily apparent to one of ordinary skill in the relevant art that numerous other exchanges (including, inter alia, other types or forms of announcement messages) are easily possible and indeed are fully within the scope of the present invention. For example:

1) The PAS 404 may employ a manual (e.g., human-based) system to construct a textual equivalent of a public announcement.

2) The PAS 404 may employ a voice recognition facility to automatically construct a textual equivalent of a public announcement.

3) SPₓ's AS 410 may employ a voice recognition facility at the venue itself to construct a textual equivalent of a public announcement.

4) The PAS 404 may ‘package up’ a public announcement as a (MP3, WMA, WAV, etc.) audio file for dispatch to SPₓ's AS 410.

The Set 1 412, Set 2 414, Set 3 416, and Set 4 418 exchanges that were described above are illustrative only and it will be readily apparent to one of ordinary skill in the relevant art that numerous other exchanges are easily possible and indeed are fully within the scope of the present invention.

Numerous alternatives to the exchanges that were described above are easily possible. For example, for purposes of illustration:

1) A SP may optionally allow Mary to respond to an announcement message that Mary receives on her WD.

2) A SP may optionally allow Mary to request, during (as one example) a registration process, that the SP examine the content of announcement messages that the SP receives from a PAS; leverage a range of (linguistic, statistical, heuristic, etc.) methods and a dynamically configurable set of rules/logic/data/etc. to ‘match’ the content to elements of Mary's profile; and optionally notify Mary (through, as one example, the dispatch of one or more SMS/MMS/IMS/etc. notification messages) of such matches and/or forward such matched content to Mary's WD.

3) A SP may optionally generate scheduled (e.g., daily, weekly, etc.) and/or on-demand activity, status, result, etc. reports with generated reports delivered through SMS, MMS, IMS, etc. messages; through e-mail; through a Web-based facility; etc.

4) A SP may optionally perform one or more incremental billing operations as it completes, for example, the various processing activities that were described above. An incremental billing operation may be triggered by configurable thresholds such as, possibly inter alia, total inbound and/or outbound message count, individual or aggregate inbound and/or outbound message volume, a PAS-specific fee or charge, value-add services provided, etc. A SP may optionally preserve some or all of any such activities within, for example, one of its database, etc. environments.

A SP may optionally allow advertisers to register and/or provide (e.g., directly, or through links/references to external sources) advertising content.

The (confirmation, notification, update, announcement, notification, report, etc.) message(s) that were described above may optionally contain an informational element—e.g., a public service announcement, a relevant or applicable factoid, etc. The informational element may be selected statically (e.g., all generated messages are injected with the same informational text), randomly (e.g., a generated message is injected with informational text that is randomly selected from a pool of available informational text), or location-based (i.e., a generated message is injected with informational text that is selected from a pool of available informational text based on the current physical location of the recipient of the message as derived from, as one example, a GPS/LBS facility).

The (confirmation, notification, update, announcement, notification, report, etc.) message(s) that were described above may optionally contain advertising—e.g., textual material if an SMS model is being utilized, multimedia (images of brand logos, sound, video snippets, etc.) material if an MMS model is being utilized, etc. The advertising material may be selected statically (e.g., all generated messages are injected with the same advertising material), randomly (e.g., a generated message is injected with advertising material that is randomly selected from a pool of available material), or location-based (i.e., a generated message is injected with advertising material that is selected from a pool of available material based on the current physical location of the recipient of the message as derived from, as one example, a GPS/LBS facility).

The (confirmation, notification, update, announcement, notification, report, etc.) message(s) that were described above may optionally contain promotional materials (e.g., text, still images, video clips, etc.).

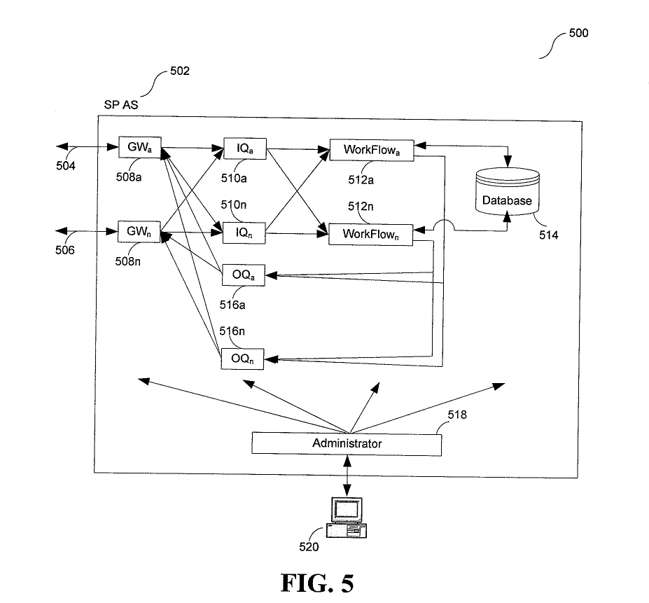

FIG. 5 and reference numeral 500 provide a diagrammatic presentation of aspects of an exemplary SP AS. The illustrated AS 502 contains several key components—Gateways (GWₐ 508ₐ→GWₙ 508ₙ in the diagram), Incoming Queues (IQₐ 510ₐ→IQₙ 510ₙ in the diagram), WorkFlows (WorkFlowₐ 512ₐ→WorkFlowₙ 512ₙ in the diagram), Database 514, Outgoing Queues (OQₐ 516ₐ→OQₙ 516ₙ in the diagram), and an Administrator 518. It will be readily apparent to one of ordinary skill in the relevant art that numerous other components are possible within an AS.

A dynamically updateable set of one or more Gateways (GWₐ 508ₐ→GWₙ 508ₙ in the diagram) handle incoming (e.g., SMS/MMS/IMS/etc. messaging, PAS announcement, etc.) traffic 504/506 and outgoing (e.g., SMS/MMS/IMS/etc. messaging, announcement messaging, etc.) traffic 504/506. Incoming traffic is accepted and deposited on an intermediate or temporary Incoming Queue (IQₐ 510ₐ→IQₙ 510ₙ in the diagram) for subsequent processing. Processed artifacts are removed from an intermediate or temporary Outgoing Queue (OQₐ 506ₐ→OQₙ 516ₙ in the diagram) and then dispatched.

A dynamically updateable set of one or more Incoming Queues (IQₐ 510ₐ→IQₙ 510ₙ in the diagram) and a dynamically updateable set of one or more Outgoing Queues (OQₐ 516ₐ→OQₙ 516ₙ in the diagram) operate as intermediate or temporary buffers for incoming and outgoing traffic.

A dynamically updateable set of one or more WorkFlows (WorkFlowₐ 512ₐ→WorkFlowₙ 512ₙ in the diagram) remove incoming traffic from an intermediate or temporary Incoming Queue (IQₐ 510ₐ→IQₙ 510ₙ in the diagram), perform all of the required processing operations (more about this below), and deposit processed artifacts on an intermediate or temporary Outgoing Queue (OQₐ 516ₐ→OQₙ 516ₙ in the diagram).

The Database 514 that is depicted in FIG. 5 is a logical representation of the possibly multiple physical repositories that may be implemented to support, inter alia, configuration, profile, monitoring, alerting, etc. information. The physical repositories may be implemented through any combination of conventional Relational Database Management Systems (RDBMSs) such as Oracle, through Object Database Management Systems (ODBMSs), through in-memory Database Management Systems (DBMSs), or through any other equivalent facilities.

An Administrator 518 provides management or administrative control over all of the different components of an AS through, as one example, a Web-based interface 520. It will be readily apparent to one of ordinary skill in the relevant art that numerous other interfaces (e.g., a data feed, an Application Programming Interface [API], etc.) are easily possible.

Through flexible, extensible, and dynamically updatable configuration information a WorkFlow component may be quickly and easily realized to support any number of activities. For example, WorkFlows might be configured to support the registration of a MS; the extraction of data values from an incoming message; the editing/validation of data values; the enhancement/augmentation of data values; an array of analysis operations; the generation and dispatch of reply messages; the generation of scheduled and/or on-demand reports; the interaction with a PAS; the interaction with external and/or internal sources of data or information; etc. The specific WorkFlows that were just described are exemplary only; it will be readily apparent to one of ordinary skill in the relevant art that numerous other WorkFlow arrangements, alternatives, etc. are easily possible.

A SP may maintain a repository (e.g., a database) into which selected details of all administrative, messaging, processing, etc. activities may be recorded. Among other things, such a repository may be used to support:

1) Scheduled (e.g., daily, weekly, etc.) and/or on-demand reporting with report results delivered through SMS, MMS, IMS, etc. messages; through e-mail; through a Web-based facility; etc.

2) Scheduled and/or on-demand data mining initiatives (possibly leveraging or otherwise incorporating one or more external data sources) with the results of same presented through visualization, Geographic Information System (GIS), etc. facilities and delivered through SMS, MMS, IMS, etc. messages; through e-mail; through a Web-based facility; etc.

Numerous alternatives to the arrangements that were described above are easily possible. For example, for purposes of illustration, one or more of the functional elements of a SP may, for example, be collapsed with, or otherwise combined with, a PAS.

It is important to note that while aspects of the discussion that was presented above focused on the use of TNs and SCs, it will be readily apparent to one of ordinary skill in the relevant art that other message address identifiers are equally applicable and, indeed, are fully within the scope of the present invention.

The discussion that was just presented referenced the specific wireless messaging paradigms SMS and MMS. These paradigms potentially offer an incremental advantage over other paradigms in that native support may commonly be found on a WD that a potential MS would be carrying. However, it is to be understood that it would be readily apparent to one of ordinary skill in the relevant art that other paradigms (IMS, WAP, etc.) are fully within the scope of the present invention.

The foregoing disclosure of the preferred embodiments of the present invention has been presented for purposes of illustration and description. It is not intended to be exhaustive or to limit the invention to the precise forms disclosed. Many variations and modifications of the embodiments described herein will be apparent to one of ordinary skill in the relevant art in light of the above disclosure.

The following list defines acronyms as used in this disclosure.

| Acronym | Meaning |
|---|---|
| API | Application Programming Interface |
| AS | Application Server |
| BI | Billing Interface |
| CSC | Common Short Code |
| DBMS | Database Management System |
| GIS | Geographic Information System |
| GPS | Global Positioning System |
| GW | Gateway |
| IM | Instant Messaging |
| IMS | IP Multimedia Subsystem |
| IP | Internet Protocol |
| IQ | Incoming Queue |
| IVR | Interactive Voice Response |
| LBS | Location Based Services |
| MICV | Messaging Inter-Carrier Vendor |
| MMS | Multimedia Message Service |
| MS | Mobile Subscriber |
| ODBMS | Object Database Management System |
| OQ | Outgoing Queue |
| PAS | Public Address System |
| PC | Personal Computer |
| RDBMS | Relational Database Management System |
| SC | Short Code |
| SMS | Short Message Service |
| SP | Service Provider |
| TN | Telephone Number |
| WAP | Wireless Application Protocol |
| WC | Wireless Carrier |
| WD | Wireless Device |
| WS | Web Server |
| WWW | World Wide Web |

What is claimed is:

1. A method of delivering public address system announcements, comprising:
receiving notification of a location of a wireless device;
sending an inquiry message to a public address system (PAS) serving the location of the wireless device regarding whether the PAS is configured to relay PAS announcements;
receiving a response message from the PAS indicating its ability to relay PAS announcements;
sending an update message to the wireless device indicating that the PAS is configured to relay PAS announcements to the wireless device; and
receiving content of a PAS announcement from the PAS, and forwarding the content to the wireless device.

2. The method of claim 1, wherein the wireless device is a mobile telephone.

3. The method of claim 1, wherein at least one of the inquiry message, response message, update message, and content is sent via the short message service (SMS).

4. The method of claim 1, further comprising forwarding the content to the wireless device using the short message service (SMS).

5. The method of claim 1, further comprising forwarding the content to the wireless device using the multimedia message service (MMS).

6. The method of claim 1, wherein the content is received as a textual equivalent of the PAS announcement.

7. The method of claim 1, wherein the content is received as an audio file of the PAS announcement.

8. The method of claim 1, further comprising receiving a reply message from the wireless device in response to the content.

9. The method of claim 1, further comprising determining the location of the wireless device using the global positioning system (GPS).

10. A method of delivering live public address system (PAS) announcements, comprising:
receiving a notification of a location of a wireless device;
requesting, from an entity that operates a public address system (PAS) serving the location of the wireless device, that the entity electronically relay live PAS announcements;
receiving content of a live PAS announcement relayed from the PAS; and
forwarding the content to the wireless device.

11. The method of claim 10, wherein the content is received as a textual equivalent of the PAS announcement.

12. The method of claim 10, wherein the content is received as an audio file of the PAS announcement.

13. The method of claim 10, wherein the content is forwarded using the short message service (SMS).

14. The method of claim 10, wherein the content is forwarded using the multimedia message service (MMS).

15. A method of distributing live public address system announcements, comprising:
receiving, at an entity that operates a public address system (PAS), an inquiry message from an entity serving a population of mobile telephones regarding whether the PAS is configured to relay content of live PAS announcements;
sending a response message responsive to the inquiry message indicating that the PAS is configured to relay the content of live PAS announcements; and
sending content of a given live PAS announcement from the PAS to the entity serving the population of mobile telephones.

16. The method of claim 15, wherein at lease one of the inquiry message, the response message and the content is sent via the short message service (SMS).

17. The method of claim 15, further comprising forwarding the content to at least one mobile telephone within the population of mobile telephones using the short message service (SMS).

18. The method of claim 15, further comprising forwarding the content to at least one mobile telephone within the population of mobile telephones using the multimedia message service (MMS).

19. The method of claim 15, wherein the content is sent as a textual equivalent of the PAS announcement.

20. The method of claim 15, wherein the content is sent as an audio file of the PAS announcement.
